(19) United States
(12) Patent Application Publication
(10) Pub. No.: US 2009/0327121 A1
(43) Pub. Date: Dec. 31, 2009

(54) MONETARY GIFT REGISTRY METHODS AND SYSTEMS

(75) Inventors: Kevin Carroll, Centennial, CO (US); Karina Elrod, Littleton, CO (US); Julie Cannava, Highlands Ranch, CO (US); Kirsten Fry-Sanchez, Evergreen, CO (US); Shawna Landers, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Western Union Company, Englewood, CO (US)

(21) Appl. No.: 12/163,674

(22) Filed: Jun. 27, 2008

(51) Int. Cl. G06Q 40/00

(52) U.S. Cl. 705/39

(57) ABSTRACT

A method of operating a monetary gift registry includes registering one or more recipients with the monetary gift registry and creating an account for each registered recipient. Each account has a unique account identifier. Transfers of monetary value are received from one or more senders, each transfer of value accompanied by the unique identifier of one of the accounts. The deposits are accumulated into the respective accounts based at least in part on unique identifiers, and funds from at least one account are distributed. Funds may be distributed to at least one registered recipient for whom an account was created, or to a third-party merchant. At least one transfer of monetary value or distribution of funds is capable of being performed through a consumer-oriented money transfer network, or both

### BACKGROUND OF THE INVENTION

Traditional gift registries are limiting because registrants are typically able to choose only items that are stocked by and offered for sale by a particular merchant. A traditional gift registry may also be inconvenient for a purchaser of a gift for the registrant, especially if the purchaser wishes to view an item from the registry in person before purchasing. Such a viewing may require a visit to the merchant's store, and may be especially inconvenient when the purchaser and the recipient live in widely separated locations.

### BRIEF SUMMARY OF THE INVENTION

The present invention relates methods and systems for operating a gift registry wherein a sender may give cash or other monetary value to a recipient.

In one embodiment, a method of operating a monetary gift registry comprises registering one or more recipients with the monetary gift registry, creating an account for each registered recipient, and assigning a unique identifier to at least one account or registered recipient. One or more transfers of value are received from one or more senders, each deposit accompanied by the unique identifier of one of the accounts or recipients. The receipts of value are accumulated into the respective accounts based at least in part on the unique identifiers, and funds are distributed from one of the accounts to at least one registered recipient for whom the account was created. At least one deposit of monetary value is capable of being received through a consumer-oriented money transfer network, or at least one distribution of funds is capable of being performed through a consumer-oriented money transfer network, or both. In some embodiments, the method further comprises receiving from at least one recipient contact information for at least one potential sender. In some embodiments, the method further comprises notifying at least one potential sender that a particular recipient is registered with the monetary gift registry. In some embodiment, at least one potential sender is notified via one or more means selected from the group consisting of an electronic mail message, a telephone call, a short message service message, and postal mail. In some embodiments, at least one sender responds with a transfer of value by replying directly from the means by which the sender was notified. In some embodiments, the method further comprises staging a transfer of value by one means, and receiving the value by another means. In some embodiments, the method further comprises notifying a sender when the value received from the sender is delivered to the at least one recipient. In some embodiments, the method further comprises sending to at least one recipient a message composed, selected, or customized by a sender. In some embodiments, the method further comprises communicating to a sender a message composed, selected, or customized by at least one recipient. In some embodiments, the method further comprises performing at least one compliance check. In some embodiments, the method further comprises collecting one or more fees from one or more participants in the monetary gift registry. In some embodiments, the method further comprises generating a report listing the receipts of value, and senders thereof, received on behalf of a particular recipient, and providing the report to the particular recipient. In some embodiments, registering a particular recipient further comprises receiving an application for registration from the recipient online, by mail, by telephone, at an agent location, at a kiosk, through an automated teller machine, or via a mobile device. In some embodiments, receiving value further comprises receiving a transfer initiated online, at an agent location of the administrator of the monetary gift registry, by telephone, via a short message service message, at a kiosk, or via an automated teller machine. In some embodiments, the method further comprises receiving an indication that a funds distribution is to occur at a scheduled future time. In some embodiments, the method further comprises receiving funding for one of the receipts of value by means selected from the group consisting of cash, a credit account, a debit account, a stored value account, an automated clearing house transaction, a personal check, a money order, and an electronic check. In some embodiments, the method further comprises receiving funding for one of the receipts of value in cash. In some embodiments, distributing funds from one of the accounts to at least one registered recipient for whom the account was created comprises distributing funds by one or more means selected from the group consisting of cash, a credit to a credit account, a deposit to a debit account, a stored value account, an automated clearing house transaction, a check, a money order, and an electronic check. In some embodiments, distributing funds from one of the accounts to at least one registered recipient for whom the account was created comprises distributing funds in cash. In some embodiments, at least one recipient is a charitable organization.

In another embodiment, a method of operating a monetary gift registry comprises registering one or more recipients with the monetary gift registry, creating an account for at least one registered recipient, and assigning a unique identifier to at least one account or registered recipient. Value is received for one or more senders, and each receipt of value is accompanied by the unique identifier of one of the accounts or registered recipients. The received value is accumulated based, at least in part, on the unique identifiers, and funds are distributed from one of the accounts to a third-party merchant. In some embodiments, the method further comprises staging a purchase with the third-party merchant, receiving a transaction identifier from the third-party merchant, presenting the transaction identifier to the monetary gift registry, and referencing the transaction identifier in a transfer of funds from the monetary gift registry to the third-party merchant.

In another embodiment, a monetary gift registry system comprises a host computer system comprising memory, and a computer-readable medium holding instructions. The instructions are executable by the host computer system to create in the memory a database of registered recipients in the monetary gift registry, the database recording an account for at least one registered recipient and a unique identifier assigned to at least one account or registered recipient. The accumulation of receipts of value into the accounts is recorded in the database, each receipt of value received from a sender and accompanied by the unique identifier of one of the accounts or registered recipients. The distribution of funds from at least one of the accounts is also recorded in the database. At least one receipt of value is capable of being received through a consumer-oriented money transfer network, or at least one distribution of funds is capable of being performed through a consumer-oriented money transfer network, or both.

In another embodiment, a method of operating a gift registry comprises registering one or more recipients with the gift registry, and presenting to potential senders a selection of items available to give to at least one particular recipient. The selection of items includes both cash and one or more items of merchandise. In indication is received from any sender that a cash gift is to be given to the at least one particular recipient. Funding for the cash gift is received from the sender, and cash is distributed to the recipient. An indication is received from a sender that a gift of an item of merchandise is to be given to the particular recipient. Funding is received from the sender for the gift of the item of merchandise, and the item of merchandise is distributed to the recipient. In some embodiments, the funding for at least one gift is capable of being received over a consumer-oriented money transfer network, and in some embodiments, the cash is capable of being distributed to the recipient over a consumer-oriented money transfer network.

### BRIEF DESCRIPTION OF THE DRAWINGS

FIG. 1 shows a simplified conceptual diagram of a system for operating a monetary gift registry, in accordance with an example embodiment of the invention.

FIG. 2 shows a registration form for enrolling as a recipient in the monetary gift registry, in accordance with an example embodiment of the invention.

FIG. 3 shows a notification email, in accordance with an example embodiment of the invention.

FIG. 4 shows an example web page for making a gift online, in accordance with another example embodiment of the invention.

FIG. 5 shows a message from the monetary gift registry informing a sender that his gift has been delivered, in accordance with an example embodiment of the invention.

FIG. 6 shows a report detailing deposits of monetary value received into a recipient's account, in accordance with an example embodiment of the invention.

FIG. 7 shows an example user interface window.

FIG. 8 shows a user interface screen, in accordance with an example embodiment of the invention.

FIG. 9 shows a portion of a checkout screen offering a recipient's gift registry account as a means of payment, in accordance with an example embodiment of the invention.

FIG. 10 shows a portion of a checkout screen enabling payment for purchase by a money transfer, in accordance with an example embodiment of the invention.

FIG. 11 shows a user interface screen for presenting the selection of items to a potential sender over the Internet, in accordance with an example embodiment of the invention.

FIG. 12 shows a portion of an online checkout process, in accordance with an example embodiment of the invention.

### DETAILED DESCRIPTION OF THE INVENTION

The present invention relates methods and systems for operating a gift registry wherein a donor or sender may give cash or other monetary value to a recipient. Because the recipient receives cash or monetary value, the recipient is not limited in the places that the gift can be used. Furthermore, the gift may be easily transferred when the recipient and the sender live in widely separated locations.

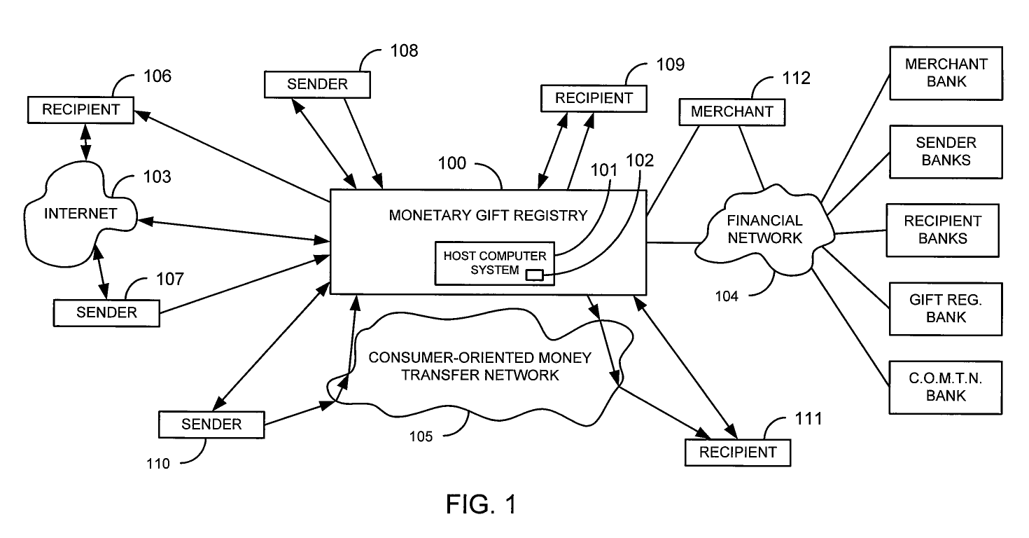

FIG. 1 shows a simplified conceptual diagram of a system for operating a monetary gift registry 100 in accordance with an example embodiment of the invention. Central to the system is a host computer system 101. Host computer system 101 may comprise one or more processors, computer readable memory 102, various control structures, and various input/output capabilities. While host computer system 101 is shown for ease of conceptualization and understanding as a single block, computer system 101 may actually comprise a single computer, or multiple interconnected computers or computer components that may be co-located or widely distributed. Memory 102 may comprise volatile memory such as processor registers, random access memory (RAM), cache memory, and the like. Memory 102 may also comprise nonvolatile memory such as read only memory (ROM), flash memory, programmable read only memory (PROM), erasable programmable read only memory (EPROM), and the like. Memory 102 may also comprise mass storage, such as one or more magnetic disk drives, magnetic tape, optical storage, and the like. Memory 102 may comprise any of these and other kinds of memory in a wide variety of combinations. Computer readable memory 102 holds instructions executable by computer 101 for administering the monetary gift registry, and holds various data files containing information relating to the operation of the monetary gift registry.

Monetary gift registry 100 works in concert with various other devices, networks, and entities. For example, monetary gift registry 100 may be connected to the Internet 103. The Internet is a global, publicly accessible network of interconnected computer networks, and enables a wide variety of communications. Monetary gift registry 100 may also be connected to a financial services network 104. Financial services network 104 may interconnect various financial institutions and enable electronic funds transfers and other associated communications.

Monetary gift registry 100 is also connected to a consumer-oriented money transfer network 105. One example of a consumer-oriented money transfer network is the extensive network operated by The Western Union Company, which has offices in Englewood, Colo., USA, and agents worldwide. A consumer-oriented money transfer network enables consumers to transfer money to other consumers or to businesses in a fast, secure way. Funds to be transferred over the consumer-oriented money transfer network may be provided by a sender by a variety of means, including, in various cases, cash, a credit account, a debit account, a stored value account, an automated clearing house transaction, and an electronic check, or by other means. For the purposes of this disclosure, cash means actual currency, including bills, coins, or both. The term “monetary value” means value measured in monetary units, such as dollars and cents, and includes cash and other forms of value such as bank account balances and the like. Often, money is distributed to a recipient in cash, but other forms of distribution are possible as well, including distribution by check, money order, deposit to a bank account, or other forms. The network includes agents that may receive funds to be transferred and that distribute funds transferred from other locations, but transfers may be made in other, automated ways without the help of an agent. The network also includes the infrastructure required for administering the system. The infrastructure may include computer systems, communications networks, storefronts, kiosks, and other items. Consumer-oriented money transfer network 105 is distinguished from financial network 104 by the fact that financial network 104 is primarily an electronic network used for exchanging funds between financial institutions. Monetary gift registry 100 and consumer-oriented money transfer network may be part of the same entity. That is, monetary gift registry 100 may be operated by the administrator of consumer-oriented money transfer network 105, or vice versa, or monetary gift registry 100 may be an aspect of consumer-oriented money transfer network 105.

Various senders and recipients interact with monetary gift registry 100. In FIG. 1, communications between monetary gift registry 100 and a sender or recipient are represented by bidirectional arrows. Communications may include a registration by a recipient, a notification of a recipient or sender, or a message passed between a sender and a recipient by monetary gift registry 100. Monetary transfers from a sender or to a recipient are represented in FIG. 1 by single-direction arrows. Communications and transfers of monetary value may take many forms, as will be described in more detail below.

Some transfers of value may take place or be settled between various banks over financial network 104. Each of the parties in the system may have a relationship with one or more banks. Not all relationships existing in the system are indicated by connectors in FIG. 1, so as to avoid unnecessary complexity of the figure. While FIG. 1 is presented in a form convenient for conceptualization of the monetary gift registry system, other relationships and interactions are also possible. For example financial network 104 or consumer-oriented money transfer network 105 may accomplish some of its interaction over the Internet 103.

In some cases, monetary gift registry 100 may interact with a merchant 112, as will be described in greater detail below. In FIG. 1, relationships between commercial entities such as merchant 112, financial network 104, monetary gift registry 100, and various banks are indicated by links without arrows. These relationships may include, without limitation, various communications, transfers, agreements, and other aspects of varying complexity and character. Not all such relationships are shown.

Recipients and senders may interact with monetary gift registry 100 in a variety of ways. For example, recipient 106 may register and communicate with monetary gift registry 100 through the Internet 103, and may receive a distribution of funds directly from monetary gift registry 100. Sender 107 may similarly communicate through the Internet, and transfer monetary value directly to monetary gift registry 100. Sender 108 and recipient 109 may both communicate and make monetary transfers directly with monetary gift registry 100. Sender 110 may communicate directly with monetary gift registry 100 and transfer funds through consumer-oriented money transfer network 105. Similarly, recipient 111 may communicate directly with monetary gift registry 100 and receive funds through consumer-oriented money transfer network 105. Other combinations are possible. For example a sender or recipient may communicate with monetary gift registry 100 through the Internet 103, and transfer monetary value through consumer-oriented money-transfer network 105.

In a method in accordance with an example embodiment of the invention, a recipient registers with the monetary gift registry. For the purposes of this disclosure, a recipient is a person or entity that will receive one or more transfers of monetary value through the monetary gift registry. In some cases, a recipient may be someone experiencing a life event that is traditionally considered a gift-giving occasion. For example, the recipient may be an engaged couple anticipating wedding gifts, or may be a student anticipating graduation gifts. In other cases, a recipient may be a charitable organization, and the monetary gift registry may be used for fundraising for the organization. Application for registration may be made in any of a number of ways, including, without limitation, online, by mail, by telephone, at an agent location, at a kiosk, through an automated teller machine, or via a mobile device. For the purposes of this disclosure, performing a task by telephone includes, without limitation, performing the task through an interactive voice response (IVR) system, a touch-tone interface, or by speaking with a customer service representative.

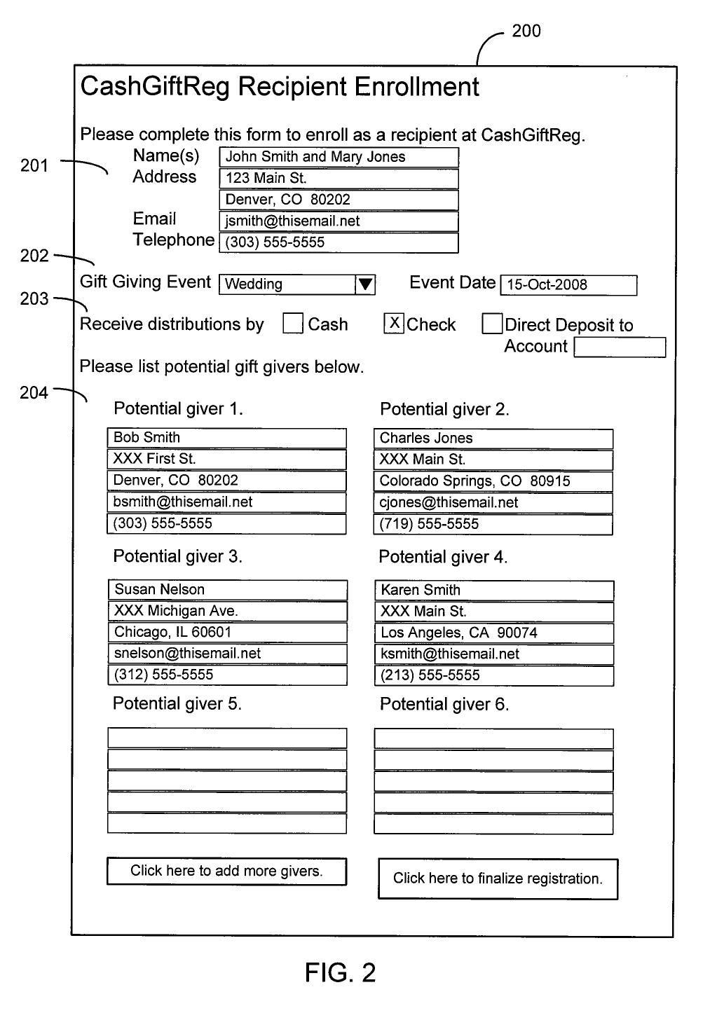

FIG. 2 shows a registration form 200 for enrolling as a recipient in the monetary gift registry, in accordance with an example embodiment of the invention. Example form 200 is shown as presented on a web page for online enrollment, but a similar paper form may be used as well. On form 200, the recipients provide their contact information 201, indicate what kind of occasion the gifts may commemorate 202, and indicate how distributions from their gift account are to be made 203. More or fewer items of information may be collected on the enrollment form.

Once a recipient registers with the monetary gift registry, an account is created and given a unique account identifier. The identifier may be simply an account number, but may also be a text string, a set of alphanumeric characters, or another kind of identifier. A record of the account is preferably placed in memory 102 of host computer system 101. The registry may register a large number of recipients, and an account is created for each registered recipient. Computer system 101 may keep a database of information about registered recipients. Such a database may include at least a list of recipients registered with the monetary gift registry, the unique account identifier of each account, and a balance in each account.

In some embodiments, a recipient may provide a list 204 of potential donors or senders. For the purposes of this disclosure, the terms “donor” and “sender” are interchangeable, and refer to persons or entities who transferring funds to the recipient through the monetary gift registry, or who are or may be interested in transferring funds. For example, an engaged couple may provide a list of guests invited to the couple's wedding. The recipient may also provide contact information for each of the potential senders. The contact information for a potential sender may include, for example, the potential sender's name, electronic mail (email) address, postal mail address, telephone number, or other items.

The monetary gift registry may use the contact information to notify the potential senders that the recipient is registered with the registry, invite the potential senders to transfer funds to the recipient, and provide instructions for doing so. For example, the monetary gift registry may send an email message to each potential sender for whom an email address is available, or may use an automated dialing system to place telephone calls with recorded information for those potential senders for whom a telephone number is available. Other notification methods, such as short message service (SMS) messages and postal mail may also be used. A potential sender may be contacted by one or more methods. Preferably, the instructions for contributing include the account identifier of the account associated with the recipient. Preferably, at least one sender responds with a deposit of monetary value into the account of the recipient, and the deposits are accumulated into the respective recipient accounts. For the purposes of this disclosure, a single deposit may be accumulated, or multiple deposits may be accumulated.

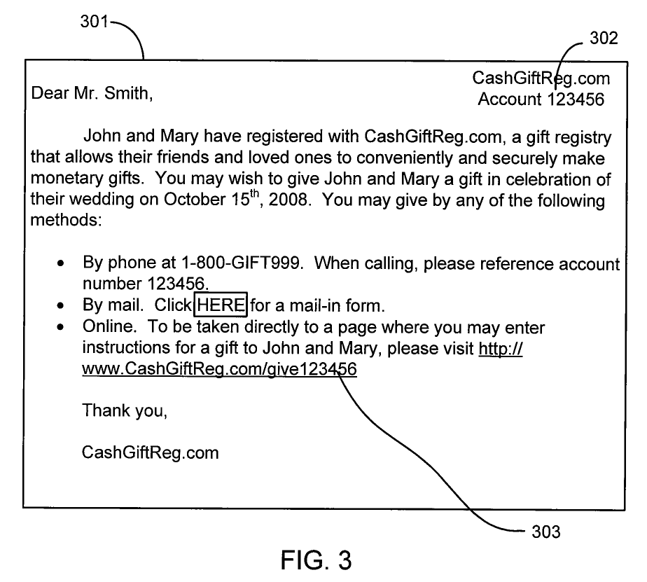

In accordance with another example embodiment of the invention, a sender may respond with a deposit of monetary value by replying directly from the means by which the sender was notified. For example, if a potential sender is notified by email of recipient's registration, the notification email may contain a link to a donation website. An example notification email 301 is shown in FIG. 3. Notification email 301 includes an account identifier 302, and instructions for how to make a gift. Also included is a hyperlink 303, which, when selected, directs the potential sender to a web page that enables online giving. In this way, a sender can deposit monetary value by replying directly from email 301, the means by which the sender was notified. Other mechanisms may also be employed to enable a sender to respond directly from the means by which the sender was notified. For example, if the notification is by pre-recorded messaged delivered by automated telephone call, the potential sender may be given the option to give using an interactive voice response (IVR) or touch-tone system during the notification telephone call. Or an executable object may be embedded in a notification email, enabling the sender to complete a gift form and return the gift information electronically. Other examples of responding with a deposit of monetary value by replying directly from the means by which the sender was notified may be envisioned.

A receipt of value at the gift registry from a sender for the recipient's benefit may be initiated by any of a variety of methods. For example, a sender may visit an agent of consumer-oriented money transfer network 105 and initiate a transfer in person. The sender may initiate a gift online, by telephone, via an SMS message, at a kiosk, through an automated teller machine, or by another means. The resulting transfer may be funded by any of a variety of methods. For example, a sender may present cash to an agent of consumer-oriented money transfer network 105, and may also provide the unique account identifier of the recipient's account at monetary gift registry 100. The money would then be transferred over consumer-oriented money transfer network 105 to monetary gift registry 100, and recorded in the recipient's account.

Many other funding mechanisms and transfer methods are possible. For example, a sender may present a credit card for funding a gift from a credit account, or may present a debit card for funding a gift from a debit account, or may present a stored value card for funding a gift from a stored value account. Similarly, funds may be transferred using an automated clearing house (ACH) transfer, an electronic check, by a personal check, using a money order, or by other means. Of course, a recipient may also be a sender, depositing monetary value in his or her own account or the account of another.

If a credit card, debit card, stored value card, or other kind of presentation instrument is presented to the administrator of the monetary gift registry, the administrator may assume the role of a merchant and obtain approval for the transaction in the usual way. That is, the administrator may contact a processing or acquiring system with details of the proposed transaction, and the processing or acquiring system may contact the issuer of the instrument for transaction approval, which is then transmitted back to the administrator. The resulting funds transfer may take place through existing clearance channels. For example, a credit card issuer may instruct its bank to transfer funds to a bank holding funds for the administrator of the monetary gift registry. A presentation instrument may be presented to the gift registry administrator via telephone, through an Internet website, through an automated teller machine, via a mobile device, or by other methods.

In another example embodiment, a presentation instrument may be presented to an agent of consumer-oriented money transfer network 105, who then obtains transaction approval and transfers the resulting funds to the monetary gift registry administrator. Many other combinations are possible within the scope of the appended claims.

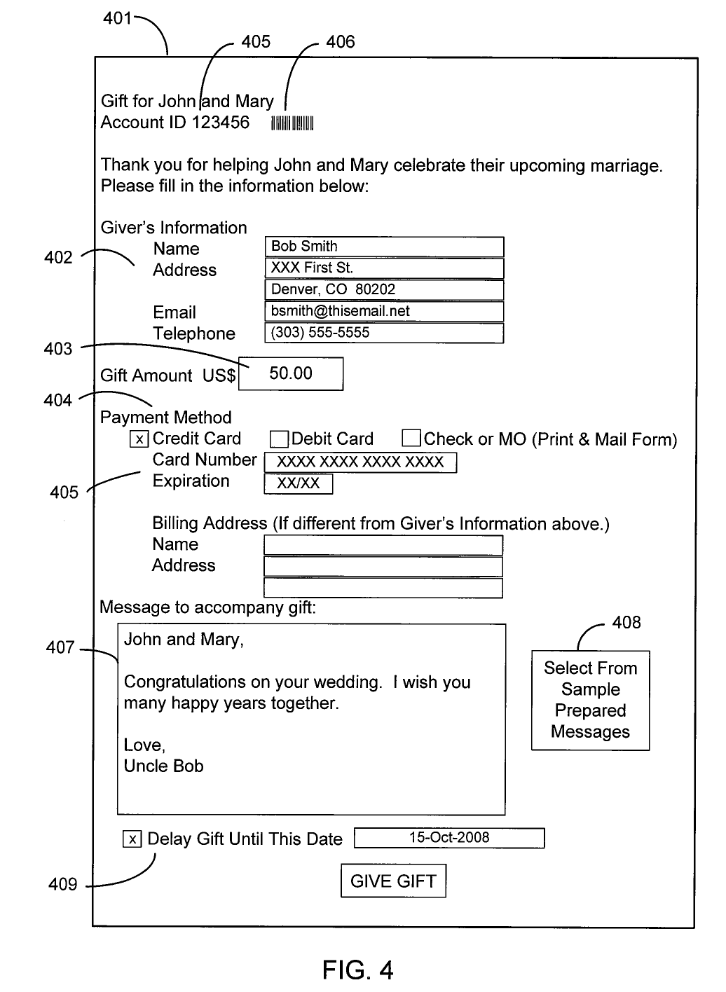

FIG. 4 shows an example web page 401 for making a gift online, in accordance with another example embodiment of the invention. Web page 401 may be reached, for example, by clicking on hyperlink 303 in example notification email 301. On web page 401, the sender confirms his or her personal information 402, making changes as required, indicates the amount of the gift 403, and indicates a mode of payment 404. In this example, the funding choices are a credit card, debit card, or check. If a credit or debit card is used, the sender enters the card information.

If the sender prefers to send a check, the page may be printed and mailed to the administrator of the monetary gift registry. The printed page will include account identifier 405, which may be encoded by a bar code 406 or other means to facilitate processing. Indicating online that a gift is to be made, but paying later by check is an example of staging a deposit of monetary value by one means (online) and the registry receiving the deposit by another means (a check in the mail). Other examples include staging a gift online, by telephone, or by other means, and funding the gift later at an agent location using cash, a stored value card, a credit card, a check, or other payment means. Other examples of staging a deposit of monetary value by one means and the registry receiving the deposit by another means may be envisioned.

If the sender wishes, he or she may compose a message 407 to be conveyed to the recipient at the time funds are distributed to the recipient. In this way, the sender may express any personal wishes or congratulations to the recipient. The registry may also provide a selection of sample prepared messages, appropriate for various occasions, from which the sender may choose. For example, the prepared messages may include messages expressing best wishes for a couple getting married, congratulations to a graduate, a “get well soon” wish for someone who has been ill, or any number of other kinds of occasion messages. Such a message composed or selected by the sender may be delivered to the recipient by email, postal mail, or by another means. The sample messages may be editable, so that the sender may use a sample message as a template and customize it to his or her taste.

In the example of FIG. 4, the sender may also indicate 409 that the transfer of funds is to occur at some later time. For example, the sender may wish to place the gift order at a time convenient to the sender, but have the funds transfer to the recipient occur on the recipient's birthday some time later. This indication is stored by the gift registry, and the funds transfer performed at the scheduled future time. Especially when the recipient is a charitable organization, the gift order may be considered a pledge to donate at the future time.

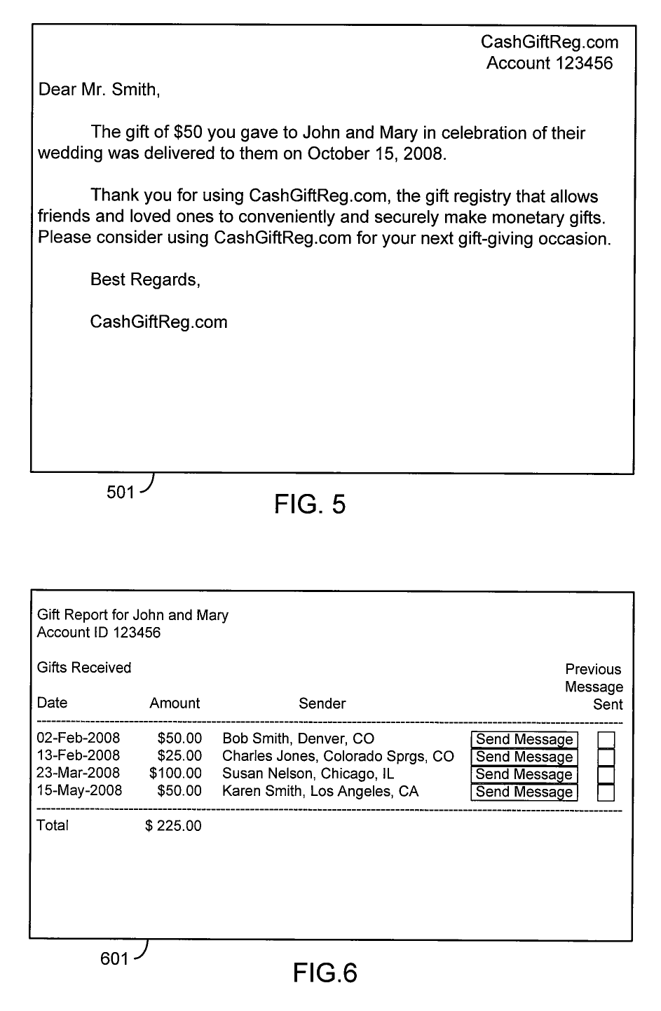

Monetary gift registry 100 may provide other messaging services as well. For example, the registry may notify a sender that his or her gift has been delivered or that the recipient has been notified that the gift is available. FIG. 5 shows a message 501 from monetary gift registry 100 informing a sender that his gift has been delivered. The message of FIG. 5 is configured as an electronic mail message, but other means may be used to inform the sender as well. For example, the sender may be informed by a letter in postal mail, by a telephone call, or by other means.

Another messaging service that the monetary gift registry may offer is to generate and provide to a recipient a summary report detailing the transfers of value received into the recipient's account, and the names and any available contact information for the respective senders. FIG. 6 shows such a report 601, in accordance with an example embodiment of the invention. Report 601, or a similar report, may be provided on paper or electronically, for example in an email or on a web page. A report of this kind enables the recipient to know how much monetary value has been received, and provides a record of all of the senders, for example so that the recipient will know whom to thank for gifts.

In accordance with another example embodiment of the invention, the monetary gift registry may assist the recipient in communicating with senders. This may be especially conveniently accomplished if the summary report is provided electronically, either in an email or on a web page. The summary report of FIG. 6 is in a form convenient for displaying on a web page. Preferably, the recipient accesses the report by logging into the monetary gift registry system using a login identifier provided by the registry, and a self-selected password. The login identifier may be but need not be the recipient's unique account identifier.

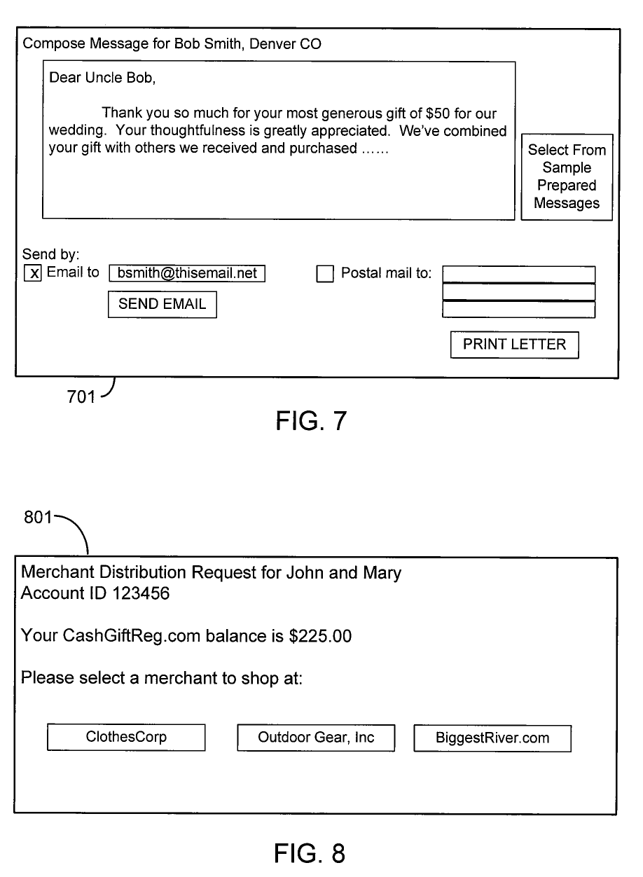

Online summary report 601 lists each gift received, and also gives the recipient an option to compose, select, or customize a message to be communicated to each sender. In this example, when the recipient clicks on “Send Message” for a particular donor or sender, a user interface window such as window 701, shown in FIG. 7, may appear. In user interface window 701, the recipient can compose a personal message or choose from a selection of prepared messages, and may indicate that the selected or composed message is to be delivered by email or by postal mail. Other delivery methods may be offered as well. A recipient may use this messaging capability to send thank-you notes to senders who made gifts on the recipient's behalf, or for other communications. The sample prepared messages may be editable so that a recipient can use a sample message as a template and customize it to his or her taste

In accordance with another example embodiment of the invention, the administrator of the monetary gift registry may wish to perform one or more compliance checks at various stages in the process of operating the registry. For example, when a sender makes a gift, the administrator may wish to verify that the means that the sender has presented for payment is backed by sufficient credit or value to fully fund the gift. These verifications may be performed using existing payments processing channels. Or, before registering a recipient, the administrator may wish to verify that any eventual transfers of money will not arouse suspicions of money laundering or other illegal activity.

In accordance with another example embodiment of the invention, the administrator of the monetary gift registry may collect a fee from one or more participants in the monetary gift registry. For the purposes of this disclosures, all recipients, senders, merchants, and banks involved in a transaction with the monetary gift registry are considered participants in the monetary gift registry. For example, the administrator may collect a percentage of each gift from the respective sender, in exchange for processing the gift. Or, the administrator may collect a processing fee for each distribution of funds to a recipient. Other fees may be envisioned. For example, the administrator may charge a fee for sending a message between a sender and a recipient, especially if the message is to be sent by postal mail.

Distributions of funds from an account to its designated recipient may be made in any of a variety of ways. For example, a recipient may visit an agent of the consumer-oriented money transfer network and receive the funds distribution in person, or the funds distribution may be received electronically or by postal mail. The funds may be distributed in cash, by check, by money order, as a credit to a credit account, as a deposit into a debit account, via an electronic check, in a stored value account, or funds may be electronically deposited directly in to the recipient's bank account via an automated clearing house transaction. Other distribution mechanism are possible as well.

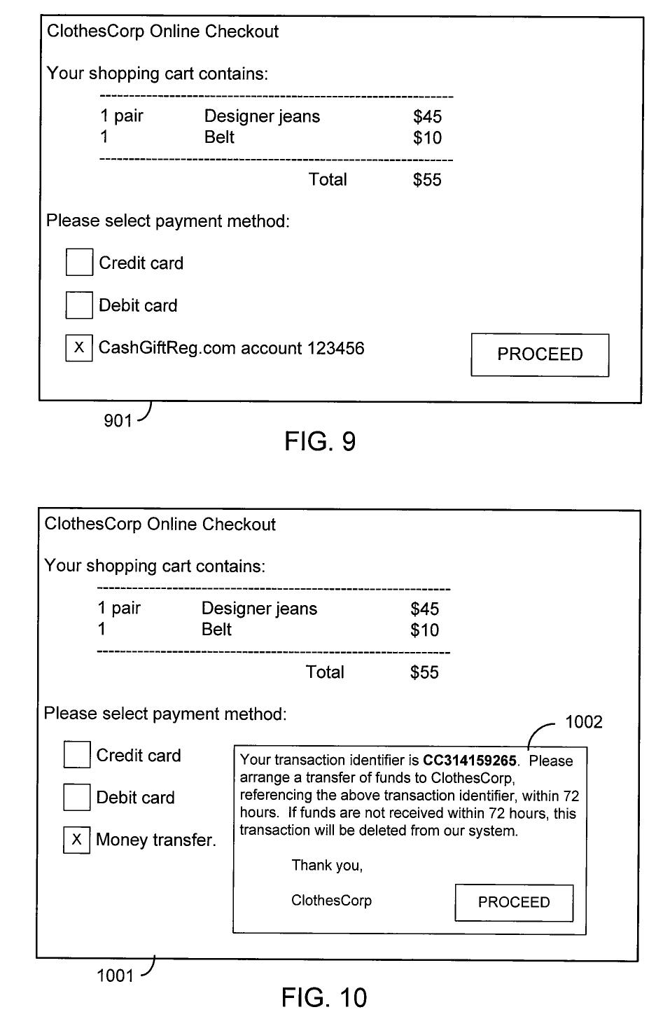

In another example embodiment of the invention, funds are distributed from a recipient's account not to the recipient, but to a third-party merchant 112 at the direction of the recipient. For example, a recipient may wish to order an item from merchant 112, and pay for the item using funds from his or her account in monetary gift registry 100. Preferably, merchant 112 and monetary gift registry 100 have a pre-existing agreement, wherein a recipient can, in seamless operation, place an order for the item and instruct that funds be transferred to the merchant in exchange for the item. FIG. 8 shows an example user interface screen 801 enabling a recipient to initiate these instructions online. Preferably, clicking on one of the merchant links in screen 801, hosted by monetary gift registry 100, takes the recipient to a shopping page hosted by the respective merchant. The shopping page may enable the user to fill a “shopping cart” or otherwise select items to purchase. Because the merchant shopping page was reached from screen 801, hosted by monetary gift registry 100, information about the recipient's gift registry account may be transmitted to merchant 112, and the recipient's monetary gift registry account may be included in the payment options in the checkout process at the merchant shopping site. FIG. 9 shows an example portion of a checkout screen 901 offering the recipient's gift registry account as a means of payment.

Alternatively, the recipient may select items from a merchant 112, stage a purchase of the items with the merchant 112, receive a transaction identifier, present the transaction identifier to monetary gift registry 100, and then instruct monetary gift registry to transfer funds from the recipient's account to merchant 112 to pay for the items. In some embodiments, the transfer of funds may take place over consumer-oriented money transfer network 105. Systems and methods for transferring funds to pay for a staged purchase are described in pending U.S. Pat. No. 6,994,251 of Hansen et al. and entitled “Cash payment for remote transactions”, the entire disclosure of which is incorporated herein by reference.

FIG. 10 shows an example portion of a checkout screen 1001 enabling payment for an online purchase by a money transfer. When the recipient selects “Money transfer” as a form of payment, pop-up window 1002 informs the recipient of a transaction identifier, and that a transfer is expected within a restricted time period (72 hours in this example).

While these embodiments wherein funds are distributed to a merchant have been described using a web-based interface performed online, such transactions may be similarly accomplished using other means as well. For example, a purchase transaction may be staged in person at a retail location of merchant 112, by telephone, by mail order, or by other means.

In accordance with another example embodiment of the invention, a gift registry may offer the opportunity for a sender to give a cash gift or a gift of an item of merchandise, or both. A gift registry of this kind may be operated by a system similar to that shown in FIG. 1. Recipients may be registered, and potential senders notified of the registration. Senders are presented with a selection of items that can be given to a particular registered recipient. The items include cash (actual currency) and various items of merchandise.

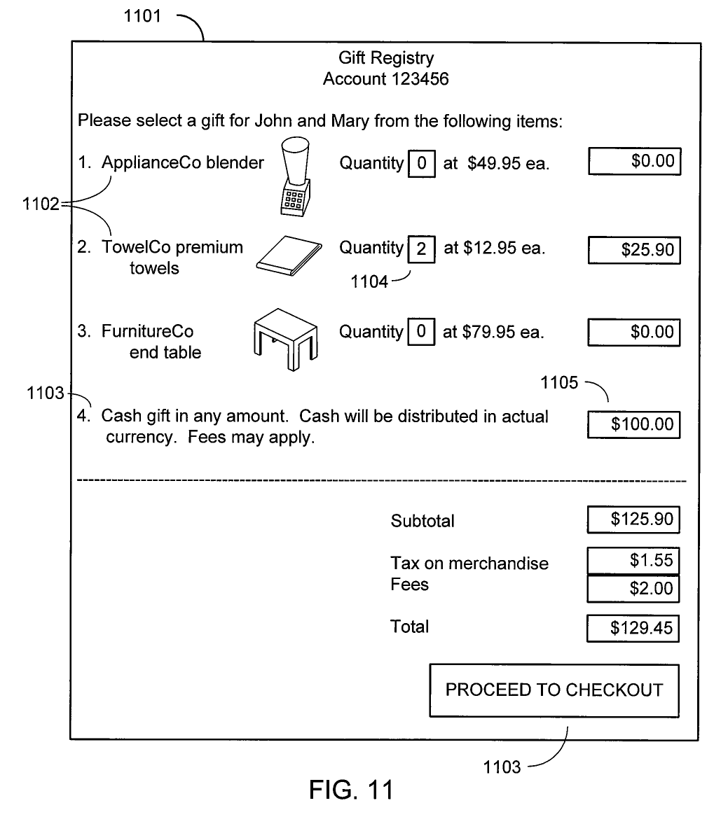

FIG. 11 shows a user interface screen 1101 for presenting the selection of items to a potential sender over the Internet, in accordance with an example embodiment of the invention. Of course, the presentation could be made in other ways, including in person at a merchant location. The selection of items that can be given includes items of merchandise 1102 and cash 1103. Preferably, the items of merchandise presented to potential senders are selected by the recipient in conjunction with the recipient's registration with the gift registry.

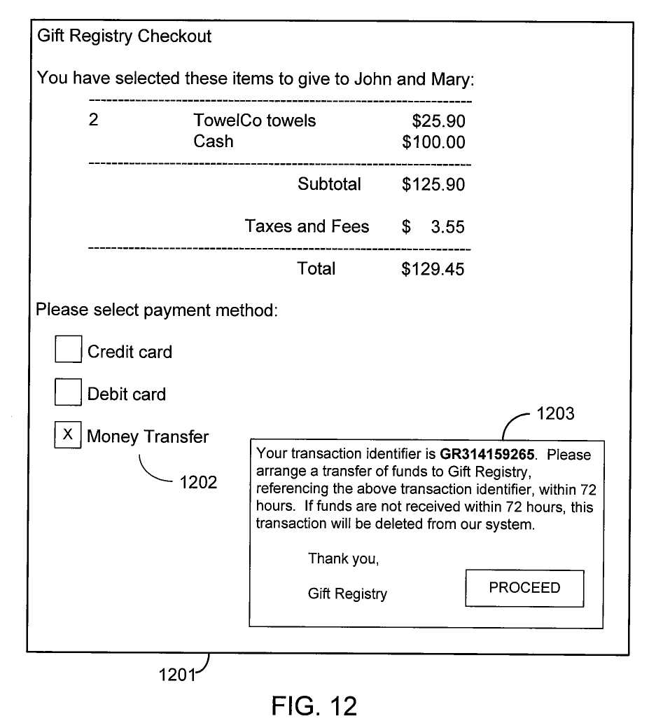

In the example of FIG. 11, a sender has indicated a gift 1104 of two towels and a gift 1105 of $100 to be distributed in cash. Any particular sender may elect to give merchandise alone, cash alone or both cash and merchandise. Once a sender has made his or her selection, the “Proceed to Checkout” button 1106 is clicked and a checkout screen 1201 as shown in FIG. 12 may appear, in accordance with an example embodiment of the invention. In example checkout screen 1201, the sender is given payment options. One of the payment options may be a money transfer 1202 over a consumer-oriented money transfer network. If the money transfer option is selected, a pop-up window such as window 1203 may appear, giving instructions for making payment by money transfer. After payment is received, any merchandise and cash are distributed to the recipient.

In some embodiments, distributions of cash may be made over the consumer-oriented money transfer network. To effect a distribution in cash, the gift registry may transfer the gift amount to the consumer-oriented money transfer network, along with identifying information about the recipient to whom cash is to be distributed. Besides the name and other personal information about the recipient, the identifying information may also include a transaction identifier, account number, or other unique identifier for the particular transfer. The gift registry may also send to the recipient the transaction identifier, account number, or other unique identifier, along with a notification that the funds are available for pickup. Preferably, the recipient goes to an agent location of the consumer-oriented money transfer network, and presents identification and any unique transaction identifier given by the gift registry. Once the recipient is thus authenticated, the agent gives the recipient the proper amount of cash.

The invention has now been described in detail for the purposes of clarity and understanding. However, those skilled in the art will appreciate that certain changes and modifications may be practiced within the scope of the appended claims.

What is claimed is:

1. A method of operating a monetary gift registry, comprising:
registering at a host computer system one or more recipients with the monetary gift registry;
creating in a database an account for at least one of the registered recipients;
assigning in the database a unique identifier to at least one account or registered recipient;
receiving value from one or more senders, each receipt of value accompanied by the unique identifier of one of the accounts or recipients;
accumulating the value based, at least in part, on the unique identifiers; and
distributing funds from at least one of the accounts to at least one of the registered recipients for whom the account was created;
wherein at least one receipt of value is capable of being received through a consumer-oriented money transfer network, or at least one distribution of funds is capable of being performed through a consumer-oriented money transfer network, or both.

2. The method of claim 1, further comprising receiving from at least one recipient contact information for at least one potential sender.

3. The method of claim 1, further comprising notifying at least one potential sender that a particular recipient is registered with the monetary gift registry.

4. The method of claim 3, wherein the at least one potential sender is notified via one or more means selected from the group consisting of an electronic mail message, a telephone call, a short message service message, and postal mail.

5. The method of claim 4, wherein at least one sender responds with a transfer of value by replying directly from the means by which the sender was notified.

6. The method of claim 1, further comprising:
staging a transfer of value by one means; and
receiving the value by another means.

7. The method of claim 1, further comprising notifying a sender when the value received from the sender is delivered to the at least one recipient.

8. The method of claim 1, further comprising sending to at least one recipient a message composed, selected, or customized by a sender.

9. The method of claim 1, further comprising communicating to a sender a message composed, selected, or customized by at least one recipient.

10. The method of claim 1, further comprising performing at least one compliance check.

11. The method of claim 1, further comprising collecting one or more fees from one or more participants in the monetary gift registry.

12. The method of claim 1, further comprising:
generating a report listing the receipts of value, and senders thereof, received on behalf of a particular recipient; and
providing the report to the particular recipient.

13. The method of claim 1, wherein registering a particular recipient further comprises receiving an application for registration from the recipient online, by mail, by telephone, at an agent location, at a kiosk, through an automated teller machine, or via a mobile device.

14. The method of claim 1, wherein receiving value further comprises receiving a transfer initiated online, at an agent location of the administrator of the monetary gift registry, by telephone, via a short message service message, at a kiosk, or via an automated teller machine.

15. The method of claim 1, further comprising receiving an indication that a funds distribution is to occur at a scheduled future time.

16. The method of claim 1, further comprising receiving finding for one of the receipts of value by means selected from the group consisting of cash, a credit account, a debit account, a stored value account, an automated clearing house transaction, a personal check, a money order, and an electronic check.

17. The method of claim 1, further comprising receiving funding for one of the receipts of value in cash.

18. The method of claim 1, wherein distributing funds from one of the accounts to at least one registered recipient for whom the account was created comprises distributing funds by one or more means selected from the group consisting of cash, a credit to a credit account, a deposit to a debit account, a stored value account, an automated clearing house transaction, a check, a money order, and an electronic check.

19. The method of claim 1, wherein distributing funds from one of the accounts to at least one registered recipient for whom the account was created comprises distributing funds in cash.

20. The method of claim 1, wherein at least one recipient is a charitable organization.

21. A method of operating a monetary gift registry, comprising:
registering one or more recipients with the monetary gift registry;
creating an account for at least one registered recipient;
assigning a unique identifier to at least one account or registered recipient;
receiving value from one or more senders, each receipt of value accompanied by the unique identifier of one of the accounts or recipients;
accumulating the received value based, at least in part, on the unique identifiers; and
distributing funds from one of the accounts to a third-party merchant.

22. The method of claim 21, further comprising:
staging a purchase with the third-party merchant;
receiving a transaction identifier from the third-party merchant;
presenting the transaction identifier to the monetary gift registry; and
referencing the transaction identifier in a transfer of funds from the monetary gift registry to the third-party merchant.

23. A monetary gift registry system, comprising:
a host computer system comprising memory; and
a computer-readable medium holding instructions executable by the host computer system to
create in the memory a database of registered recipients in the monetary gift registry, the database recording an account for at least one registered recipient and a unique identifier assigned to at least one account or registered recipient;
record in the database the accumulation of receipts of value into the accounts, each receipt of value received from a sender and accompanied by the unique identifier of one of the accounts or recipients; and
record in the database the distribution of funds from at least one of the accounts to at least one registered recipient for whom the account was created;
wherein at least one receipt of value is capable of being received through a consumer-oriented money transfer network, or at least one distribution of funds is capable of being performed through a consumer-oriented money transfer network, or both.

24. A method of operating a gift registry, comprising:
registering one or more recipients with the gift registry;
presenting to potential senders a selection of items available to give to at least one particular recipient, the selection of items including both cash and one or more items of merchandise;
receiving an indication from any sender that a cash gift is to be given to the at least one particular recipient;
receiving from the sender of the cash gift funding for the cash gift;
distributing cash to the at least one particular recipient;
receiving an indication from any sender that a gift of an item of merchandise is to be given to the particular recipient;
receiving from the sender of the item of merchandise funding for the gift of the item of merchandise; and
distributing the item of merchandise to the particular recipient.

25. The method of claim 24, wherein the funding for at least one gift is capable of being received over a consumer-oriented money transfer network.

26. The method of claim 24, wherein the cash is capable of being distributed to the recipient over a consumer-oriented money transfer network.
